(19) United States
(12) Patent Application Publication
(10) Pub. No.: US 2002/0002228 A1
(43) Pub. Date: Jan. 3, 2002

(54) FLAME RETARDANT POLYAMIDE RESIN COMPOSITION

(76) Inventors: TADASHI TAKEDA, KANAGAWA (JP); HIROSHI KIRIKOSHI, KANAGAWA (JP)

Correspondence Address: SUGHRUE MION ZINN MACPEAK & SEAS, 2100 PENNSYLVANIA AVENUE NW, WASHINGTON, DC, 200373202

(21) Appl. No.: 09/060,812

(22) Filed: Apr. 16, 1998

(30) Foreign Application Priority Data
Apr. 16, 1997 (JP) HEI-9-99135
Oct. 9, 1997 (JP) HEI-9-277520

(51) Int. Cl. C08K 3/38

(52) U.S. Cl. 524/405

(57) ABSTRACT

A flame retardant polyamide resin composition having excellent mechanical strength and tracking resistance. The flame retardant polyamide resin composition comprises (A) 100 parts by weight of polyamide resin, (B) from 1 to 20 parts by weight of melamine cyanurate and (C) from 5 to 120 parts by weight of a whisker comprising a metal borate.

### FIELD OF THE INVENTION

The present invention relates to a flame retardant polyamide resin composition having excellent mechanical strength and excellent tracking resistance for use in making, for example, electric/electronic parts such as connectors and switches.

### BACKGROUND OF THE INVENTION

Halogen-based compounds or phosphorus derivatives conventionally used as flame retardants for polyamide resin exhibit problems such as corrosion or coloration. To cope with these problems, methods of using melamine cyanurate (for example, JP-A-53-31759 (the term “JP-A” as used herein means an “unexamined published Japanese patent application”) or a combination of melamine cyanurate with magnesium hydroxide (for example, JP-A-7-3152, JP-A-7-310011) have been proposed.

However, these methods can hardly achieve satisfactory levels of flame resistance, tracking resistance and mechanical strength.

### SUMMARY OF THE INVENTION

The present invention has been achieved in view of the above problems of the prior art. Accordingly, it is an object of the present invention to provide a flame retardant polyamide resin composition having excellent mechanical strength and tracking resistance.

As a result of extensive investigations, the present inventors have discovered that the above-described object can be attained by blending a specific filler into a polyamide resin composition. The present invention has been accomplished based on this finding. More particularly, the present inventors have discovered that the above object is achieved by a flame retardant polyamide resin composition comprising (A) 100 parts by weight of polyamide resin, (B) from 1 to 20 parts by weight of melamine cyanurate and (C) from 5 to 120 parts by weight of a whisker comprising a metal borate.

### DESCRIPTION OF THE PREFERRED EMBODIMENTS

In the present invention, the polyamide resin (A) is a polymer compound having an acid amide (—CONH—) repeating unit. Specific examples thereof include polylactams such as polyamide 6, polyamide 11 and polyamide 12, polyamides obtained from a dicarboxylic acid and a diamine, such as polyamide 66, polyamide 610, polyamide 612 and polyamide 46, copolymer polyamides such as polyamide 6-66, polyamide 6-610 and polyamide 6-6T (T: terephthalic acid component), and semiaromatic polyamides obtained from an aromatic dicarboxylic acid such as isophthalic acid, and m-xylylenediamine or alicylcic diamine. These polyamide resins may be used either individually or in a combination of two or more thereof. The polyamide resin is not particularly limited with respect to relative viscosity, the kind of terminal group or terminal group ratio.

In the present invention, the melamine cyanurate (B) is an equimolar reaction product of melamine with cyanuric acid and can be obtained, for example, by mixing an aqueous cyanuric acid solution with an aqueous melamine solution and filtering the precipitate thus produced. The melamine cyanurate preferably has a fine powder shape having an average particle size of 100 μm or less.

The blending ratio of Component (B) to 100 parts by weight of Component (A) is from 1 to 20 parts by weight, preferably from 3 to 15 parts by weight, more preferably from 5 to 10 parts by weight. If the blending ratio is less than 1 part by weight, the flame resistance is insufficient, whereas if it exceeds 20 parts by weight, the mechanical strength and the moldability are disadvantageously reduced.

In the present invention, the whisker comprising a metal borate (C) is a whisker comprising a salt of boric acid with a 1A, 2A or 3B metal as set forth in the Periodic Table (1990). Specific examples thereof include an aluminum borate whisker and a magnesium borate whisker. The aluminum borate whisker has a composition represented by the formula: nAl₂O₃.mB₂O₃ (wherein n and m each represents an integer of from 1 to 9), and the production process thereof is not particularly limited. For example, in the case of a whisker in the above formula where n is 9 and m is 2, the physical properties are such that the average fiber diameter is from 0.5 to 1.0 μm, the average fiber length is from 10 to 30 μm, the melting point is 1,440° C. and the true specific gravity is 2.93. The magnesium borate whisker comprises a composition represented by the formula: nMgO.mB₂O₃ (wherein n and m each represents an integer of from 1 to 9), and the production process thereof is not particularly limited. For example, in the case of a whisker in the above formula wherein n is 2 and m is 1, the physical properties are such that the average fiber diameter is from 0.5 to 1.0 μm, the average fiber length is from 10 to 30 μm, the melting point is 1,340° C. and the true specific gravity is 2.91. The size of these whiskers is not particularly limited and appropriately selected depending on the end use of the polyamide resin composition. The blending ratio of Component (C) to 100 parts by weight of Component (A) is from 5 to 120 parts by weight, preferably from 10 to 100 parts by weight, more preferably from 15 to 80 parts by weight. If the blending ratio is less than 5 parts by weight, the improvement in mechanical strength is insufficient, whereas if it exceeds 120 parts by weight, dispersibility is reduced and moldability is disadvantageously deteriorated.

The whisker for use in the present invention may be previously subjected to surface treatment with various coupling agents such as silane-base, titanate-base or zircoaluminate-base coupling agents.

The resin composition of the present invention can be obtained by mixing and kneading the above-described components. The method therefor is not particularly limited, and methods commonly used in the field of synthetic resins can be used. For example, a method of dry-blending the components in a mixer such as a Henschel mixer or a tumbler and then melt-kneading the mixture in a screw-system extruder may be used. With respect to the order of mixing, a method of first melt-kneading polyamide resin and melamine cyanurate and then adding and mixing the whisker is preferred.

In manufacturing the resin composition of the present invention, various additives commonly used in the art may be blended therein within a range so as not to impair the object of the present invention, and examples thereof include a stabilizer, a lubricant, an antistatic agent, a reinforcing agent and a coloring agent.

### EXAMPLES

The present invention is described in greater detail below by reference to the following Examples, however, the present invention should not be construed as being limited thereto.

The flexural strength and the flexural modulus were determined according to ASTM D790. The tracking resistance was measured according to the KC method of IEC Publication 112, Third Edition—1979 “Method for Determining the Compapative and the Proof Tracking Indicies of Solid Insulating Materials under Moist Conditions”. The flame resistance was measured under a thickness condition of 1/32 inch according to the method of U.S. Safety Standard UL94.

The polyamide resin used in the Examples was polyamide 66 having a relative viscosity (1 wt % of polymer solution in 98 wt % sulfuric acid measured at a temperature of 25° C.) of 2.4. The melamine cyanurate used in the Examples had a particle size of from 10 to 30 μm. The metal borate whiskers used in the Examples included an aluminum borate whisker having a diameter of from 0.5 to 1.0 μm and a length of from 10 to 30 μm and a magnesium borate whisker having a diameter of from 0.5 to 1.0 μm and a length of from 10 to 30 μm.

The following fillers were also used for comparison.

| | |
|---|---|
| Potassium titanate whisker: | |
| diameter: | from 0.2 to 0.5 μm |
| length: | from 10 to 20 μm |
| Calcium silicate whisker: | |
| diameter: | from 0.1 to 0.5 μm |
| length: | from 1 to 5 μm |
| Calcium carbonate whisker: | |
| diameter: | from 0.5 to 1.5 μm |
| length: | from 15 to 25 μm |
| Glass fiber: | |
| average diameter: | 10 μm |
| average length: | 300 μm |

### Examples 1 to 4 and Comparative Examples 1 to 7

Of the components and blending amounts shown in Table 1, polyamide and melamine cyanurate were previously mixed using a tumbler and fed into a co-rotating twin-screw extruder (PCM30, manufactured by Ikegai Tekko) and the remaining components were fed in the middle of the extruder using a weight feeder to obtain pellets. The pellets thus obtained were formed into respective test pieces using an injection molding machine, and various physical properties of the test pieces were evaluated as indicated in Table 1. The results are set forth in Table 1.

TABLE 1

| | Polyamide Resin Composition (parts by weight) | | | | | | | | Evaluation of Physical Properties | | | |
|---|---|---|---|---|---|---|---|---|---|---|---|---|
| | | | | | | | | | Flexural | Flexural | Tracking | |
| | Poly- | Melamine | Aluminum | Magnesium | Potassium | Calcium | Calcium | Glass | Strength | Modulus | Resistance | Flame |
| | amide | Cyanurate | Borate | Borate | Titanate | Silicate | Carbonate | Fiber | (kgf/cm²) | (kgf/cm²) | (V) | Resistance |
| Example 1 | 100 | 8.8 | 27.2 | 0 | 0 | 0 | 0 | 0 | 1500 | 63000 | 500 | V-0 |
| Example 2 | 100 | 5.8 | 70.5 | 0 | 0 | 0 | 0 | 0 | 1850 | 92000 | 500 | V-0 |
| Example 3 | 100 | 8.8 | 0 | 27.2 | 0 | 0 | 0 | 0 | 1550 | 63800 | 500 | V-0 |
| Example 4 | 100 | 5.8 | 0 | 70.5 | 0 | 0 | 0 | 0 | 1880 | 92400 | 500 | V-0 |
| Comparative | 100 | 8.8 | 0 | 0 | 27.2 | 0 | 0 | 0 | 1450 | 61000 | 150 | V-0 |
| Example 1 | | | | | | | | | | | | |
| Comparative | 100 | 5.8 | 0 | 0 | 70.5 | 0 | 0 | 0 | 1800 | 89500 | 150 | V-0 |
| Example 2 | | | | | | | | | | | | |
| Comparative | 100 | 8.8 | 0 | 0 | 0 | 27.2 | 0 | 0 | 1200 | 68000 | 400 | HB |
| Example 3 | | | | | | | | | | | | |
| Comparative | 100 | 8.8 | 0 | 0 | 0 | 0 | 27.2 | 0 | 1250 | 48500 | 400 | V-2 |
| Example 4 | | | | | | | | | | | | |
| Comparative | 100 | 8.8 | 0 | 0 | 0 | 0 | 0 | 27.2 | 1850 | 68000 | 400 | V-2 |
| Example 5 | | | | | | | | | | | | |
| Comparative | 100 | 8.8 | 0 | 0 | 0 | 0 | 0 | 70.5 | 2600 | 105000 | 400 | V-2 |
| Example 6 | | | | | | | | | | | | |
| Comparative | 100 | 8.8 | 0 | 0 | 0 | 0 | 0 | 0 | 1200 | 35000 | 600 | V-0 |
| Example 7 | | | | | | | | | | | | |

As shown in Table 1, the polyamide resin composition of the present invention concurrently provides excellent mechanical strength, tracking resistance and flame resistance, whereas the Comparative Examples were deficient in one or more of these properties.

While the invention has been described in detail and with reference to specific embodiments thereof, it will be apparent to one skilled in the art that various changes and modifications can be made therein without departing from the spirit and scope thereof.

What is claimed is:

1. A flame retardant polyamide resin composition comprising (A) 100 parts by weight of polyamide resin, (B) from 1 to 20 parts by weight of melamine cyanurate and (C) from 5 to 120 parts by weight of a whisker comprising a metal borate.

2. The flame retardant polyamide resin composition as claimed in claim 1, wherein the metal borate (C) is at least one of aluminum borate and magnesium borate.

3. The flame retardant polyamide resin composition as claimed in claim 1, wherein said whiskers have a particle size of from 0.5 to 1.0 μm and a diameter of from 10 to 30 μm.

4. The flame retardant polyamide resin composition as claimed in claim 2, wherein said whiskers have a particle size of from 0.5 to 1.0 μm and a diameter of from 10 to 30 μm.

5. The flame retardant polyamide resin composition as claimed in claim 1, comprising from 3 to 15 parts by weight of melamine cyanurate.

6. The flame retardant polyamide resin composition as claimed in claim 1, comprising from 10 to 100 parts by weight of a whisker comprising a metal borate.

7. The flame retardant polyamide resin composition as claimed in claim 1, wherein said melamine cyanurate has an average particle size of 100 μm or less.
